(19) United States
(12) Patent Application Publication
(10) Pub. No.: US 2009/0229469 A1
(43) Pub. Date: Sep. 17, 2009

(54) AIR PURIFIER

(75) Inventors: Glennbruce S. Campbell, Memphis, TN (US); Robert K. Mathis, Cordova, TN (US); Eugene Buican, Cordova, TN (US); Stephen M. Gatchell, Cordova, TN (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(73) Assignee: HUNTER FAN COMPANY, Memphis, TN (US)

(21) Appl. No.: 12/401,781

(22) Filed: Mar. 11, 2009

Related U.S. Application Data
(60) Provisional application No. 61/036,113, filed on Mar. 13, 2008.

(51) Int. Cl. B01D 50/00

(52) U.S. Cl. 96/417; 55/385.4

(57) ABSTRACT

An air purifier (10) is disclosed including an electrically motorized fan (12). The air purifier includes a manual touch pad controller (16) which allows the manual operation of the air purifier and a computer interface which allows the user to control the fan speed through a personal computer (18). The software can allow the user to utilize the computer to automatically turn the air purifier on or off, change the fan speed, indicate the percentage of filter life remaining, and provide a mode of operation which includes a timer mode, wake mode or snooze mode that is in sync with the computer. In an air purifier wake mode, the air purifier is turned “on” whenever the computer is in an awake mode and turned “off” whenever the computer is in a sleep mode. In an air purifier snooze mode, the air purifier is turned “on” whenever the computer is in a sleep mode and turned “off” when the computer is in an awake mode.

### REFERENCE TO RELATED APPLICATION

Applicant claims the benefit of U.S. Provisional Patent Application Ser. No. 61/036,113 filed Mar. 13, 2008.

### TECHNICAL FIELD

This invention relates to air purifiers, and specifically to controllable air purifiers.

### BACKGROUND OF THE INVENTION

Air purifiers have existed for many years. Air purifiers typically include a housing in which is mounted a filter and a motorized fan to create an airflow through the filter. The motorized fan is coupled to a fan speed selection switch in order for one to choose the speed at which the internal fan of the air purifier operates.

A common problem associated with air purifiers is the timing of their use. Some people prefer for the air purifier to be turned “on” only when they are present in order to have purified air produced when they are in the vicinity of the air purifier. This reduces the amount of time the air purifier is operated thereby extending the filter life. Others prefer for the air purifier to be turned “on” only when they are not present, so that the air purifier cleanses the air when they are not in the vicinity and so that they are not bothered by the operational noise associated with the air purifier. Again, having the air purifier operate only during select time periods increases the life span of the filter.

Hence, there remains a need to operate an air purifier or the like during select times of a day depending upon the preference of a user. Accordingly, it is seen that a need remains for an air purifier that can provide less noise at desired time intervals and increase filter life. It is to the provision of such therefore that the present invention is primarily directed.

### BRIEF DESCRIPTION OF THE DRAWINGS

FIG. 1 is a schematic view of an air purifier embodying principles of the invention in a preferred form, shown with a computer.

FIG. 2 is front view of the control panel of the air purifier of FIG. 1.

FIG. 3 is a schematic view of the air purifier of FIG. 1.

FIGS. 4-7 are electrical diagrams of the air purifier of FIG. 1.

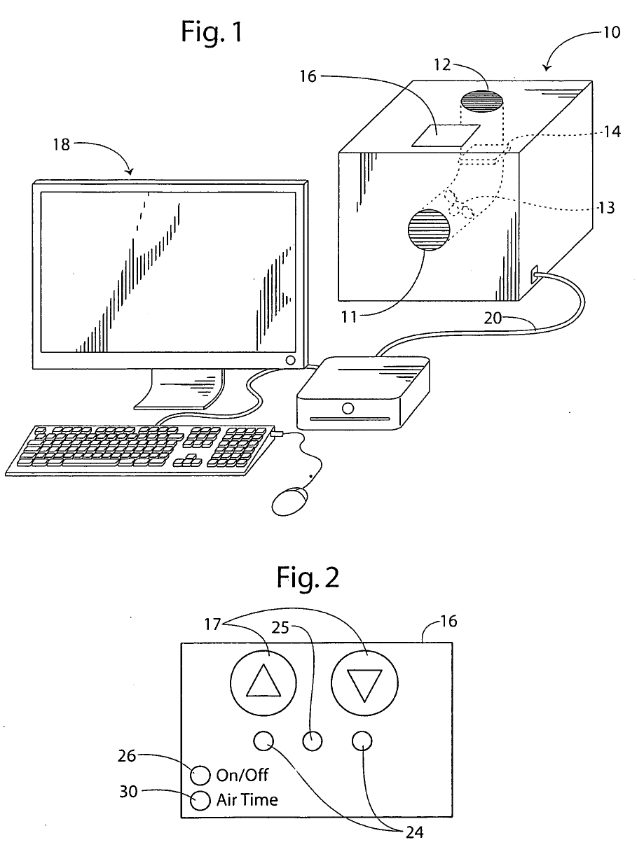

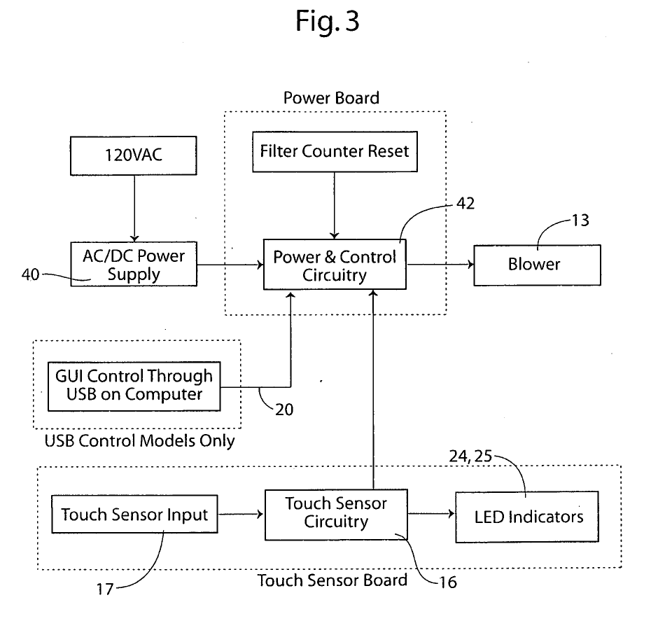

### DETAILED DESCRIPTION

With reference next to the drawings, there is shown an air purifier 10 embodying principles of the invention in a preferred form. The air purifier 10 includes a housing having and an air channel therethrough commencing with at air inlet 11 and terminating at an air outlet 12. An electrically motorized fan 13 and an air filter 14 are positioned within the air channel. The air purifier 10 includes a manual touch pad controller 16 which allows a user to turn the air purifier “on” and “off” and to change manually the fan speed. Lastly, an interface allows the user to control the operation of the air purifier and its fan speed through a personal computer 18 with appropriate software. The air purifier connects to the computer 18 via a standard USB connection 20. It should be understood that other types of connectors may be used to connect or extend between the air purifier and the computer, including wireless connectors such as RF connectors and the like.

The touch pad controller 16 is powered by standard 120 VAC power adaptor with 12 VDC and 600 mA maximum output. The touch pad controller 16 is a one touch control pad to turn the unit on and off. The controller also can change the speed of the fan through a decrease and increase buttons 17. The controller has two blue LED lights 24 and one amber LED light 25 for user feedback information. The blue LED lights 24 are used to indicate that the unit is turned on and the changing of the fan speed. The amber LED light 25 is used to indicate alerts when the time is appropriate to replace the filter. The controller also includes a pushbutton for the user to reset the filter change alert. The controller may also include an on/off button 26, and an air time button 30. The actuation of the on/off button 26 turns the air purifier on and off.

The computer utilized to control the air purifier may use a Windows or Macintosh based software GUI. The USB line 20 is connected between the air purifier 10 and the computer 18. The software is loaded on a CD or the like and shipped with the air purifier so that it may be loaded onto the computer in conventional fashion. The software can allow the user to utilize the computer to automatically turn the air purifier on or off, change the fan speed, indicate the percentage of filter life remaining, and provide a mode of operation which includes a timer mode, wake mode or snooze mode that is in sync with the computer.

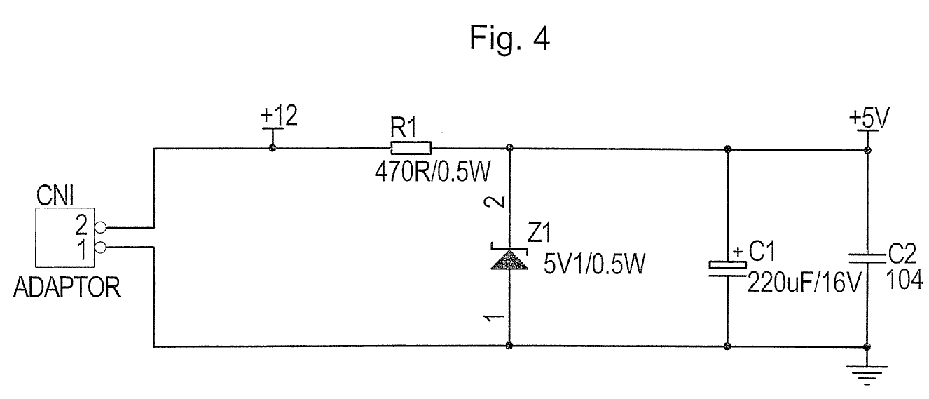

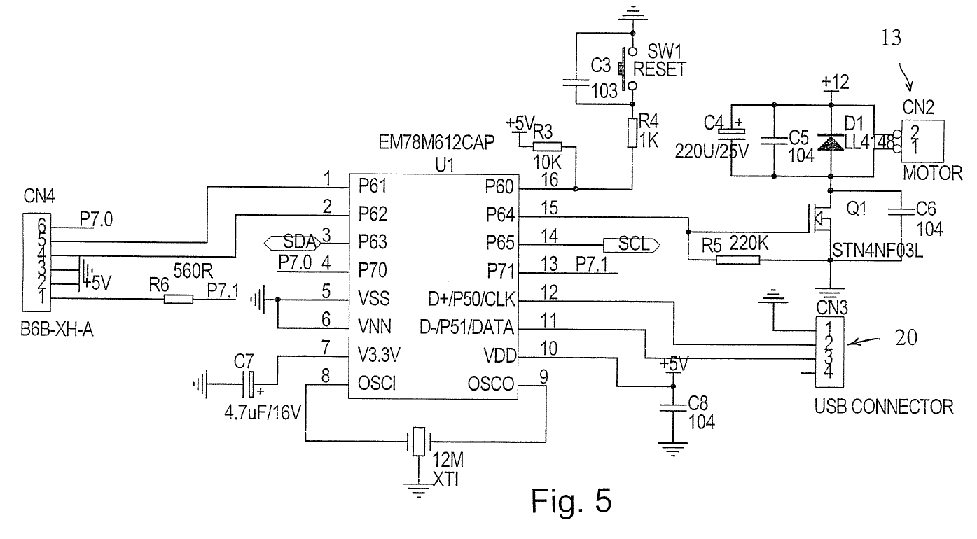

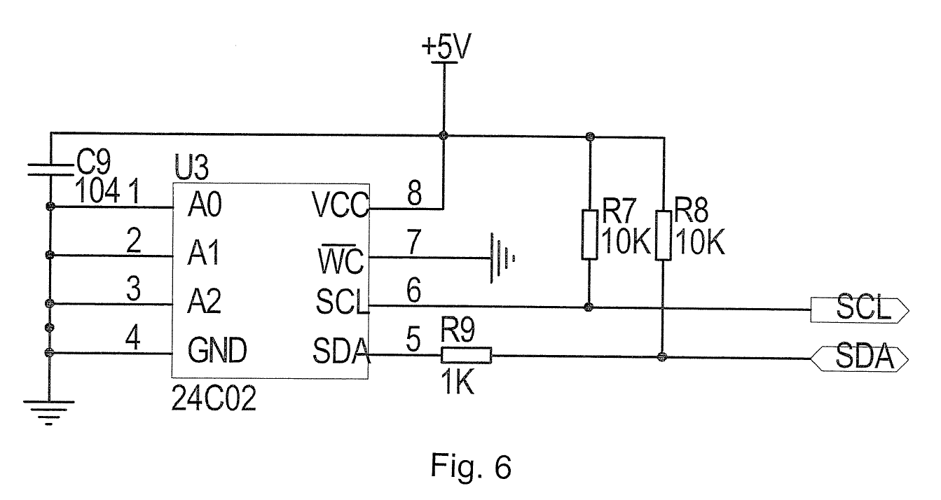

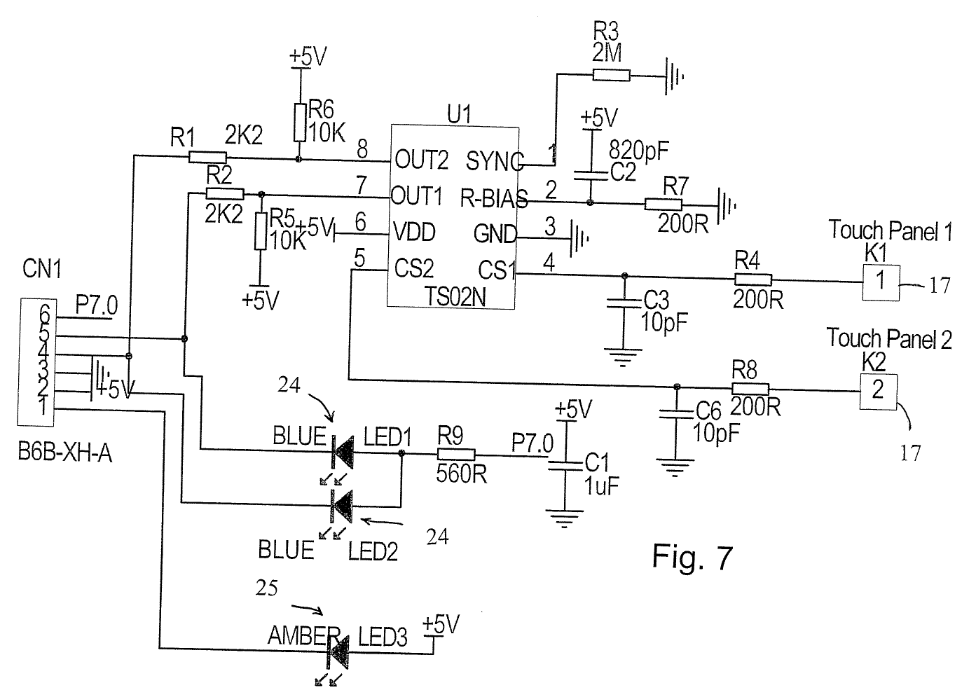

The control assembly includes the power adaptor 40, the touch pad controller 16, a main control board 42 (which includes the power supply circuit of FIG. 4, the control circuitry of FIG. 5, the non-volatile memory circuitry of FIG. 6 and the user interface module of FIG. 7, all or which or select portions of which may be considered to be a controller/microcontroller), the USB line 20, the two blue LED lights 24, and the amber LED light 25. The controller utilizes information inputted by a user through the touch pad controller 16, or alternatively through the computer 18, to control the fan on or off and vary the fan speed.

The controller may provide a current to the LED light 25 to cause it to flash in order to alert users to change the filter. This flashing of the light occurs when the controller determines that the unit has been activated for a select amount of time, for example, 2,800 hours corresponding to the life span of the filter.

An electrical schematic is shown in FIGS. 4-7. FIG. 4 shows the power supply circuitry. FIG. 5 shows the control circuitry utilizing a USB microcontroller chip (EM78M612CAP) made by Elan Microelectronics Corp. FIG. 6 shows the non-volatile memory circuitry utilizing a memory IC (TS02N) made by Atmel Corp. FIG. 7 shows the user interface module circuitry utilizing a an input IC (TS02N) made by ADSemiconductor.

In use, the user may manual turn the air purifier “on” or “off” or change the fan speed through the touch pad buttons 17 and 26. However, the user may also operate the air purifier through the use of the computer coupled to the air purifier. As a user utilizes the computer 18, the air purifier 10 may be operated in different modes so as to be is automatically turned “on” or “off” so that purified air operated automatically through the use of the three modes of operation associated with the status or state of the computer(timer mode, wake mode, and snooze mode).

In an air purifier timer mode, the air purifier turns “on” and “off” according to a programmable schedule entered into memory by the owner/operator. For example, if the user is normally working from 8 a.m. to 5 p.m., the user may schedule the air purifier to operate during those hours to provide purified air only when the user is generally present. Conversely, the air purifier may be programmed to operate during these house when the use is not typically present.

In an air purifier wake mode, the air purifier is turned “on” by the microcontroller through the receipt of a generated signal from the computer whenever the computer status, state or mode is “on”, i.e., whenever the computer is energized and the computer is in an awake mode meaning it is not in a “sleep mode” due to the non-use of the computer for a select period of time. Computer sleep modes are commonly utilized to temporarily shut down a computer in a limited fashion to conserve energy and prolong screen life through the assumption that a user is no longer present due to its non-use. Under such a computer awake mode or condition, the computer communicates the commencement of a computer “sleep mode” to the air purifier through an operational state or mode input signal and the air purifier is turned “off” through the microcontroller. Here, the assumption is that a user desires purified air only when the user is present, i.e., when the computer is “awake”. This automatic turning “off” of the air purifier when a user is not present reduces the run time of the air purifier, thereby extending the life of the filter and reducing the power consumption. The air purifier is automatically turned “on” when the computer is taken out of its “sleep mode” and is returned to an “awake mode”, wherein the computer generates another operational state or mode input signal which is sent to the air purifier microcontroller. The user may also use the computer directly or indirectly through an internet or other communication line to control the operation of the air purifier remotely or to bypass the select mode of operation.

In an air purifier snooze mode, the computer automatically turns the air purifier “on” and “off” in a fashion generally opposite to the just described wake mode. The assumption is made that the user only wants the air purifier to operate at times when the user is not present, for instance this may be utilized by those who find the noise associated with the air purifier distracting. Here, whenever the computer is “on” the computer generates an operational state or mode input signal which is received by the air purifier microcontroller that in turn automatically turns the air purifier “off”, i.e., whenever the computer is energized and the computer is not in a “sleep mode” due to the non-use of the computer for a select period of time the air purifier is turned “off”. Also, whenever the computer is turned “off” or in sleep mode the computer generates another operational state or mode input signal which the air purifier microcontroller receives and in turn turns the air purifier “on”. Again, this automatic turning off of the air purifier through the sequencing of the computer reduces the run time of the air purifier, thereby extending the life of the filter and reducing the power consumption.

It should be understood that the computer generates an operational state or mode input signal associated with the current state or mode (awake mode or sleep mode) of the computer. Of course, the absence of either a sleep mode signal or awake mode signal may be programmed as the equivalent of the actual signal. In other words, the computer may be programmed so that it only generates a sleep signal wherein the air purifier operates in one manner whenever it receives a sleep mode input signal and the air purifier operates in another manner whenever the sleep mode input signal is not being generated, i.e., the absence of a sleep mode input signal means the computer is in an awake mode even though it does not actually generate an awake mode input signal. As such, one input signal may be associated with either the computer awake mode or sleep mode while the absence of the input signal signals an opposite mode of operation.

It thus is seen that an air purifier is now provided which overcomes problems with those of the prior art. While this invention has been described in detail with particular references to the preferred embodiments thereof, it should be understood that many modifications, additions and deletions, in addition to those expressly recited, may be made thereto without departure from the spirit and scope of the invention as described by the following claims.

1. An air purifier used in conjunction with an computer, the air purifier comprising,
a housing having an air inlet and an air outlet,
a filter mounted within said housing between said air inlet and said air outlet,
a fan configured to draw air into said housing through said air inlet, through said filter and out of said housing through said air outlet,
a motor coupled to said fan, and
control means for controlling the operation of said motor, said control means including circuitry selectively energizing said motor when the computer is in a first operational state and de-energizing said motor when the computer is in a second operational state, and a connector extending between the computer and said circuitry.

2. The air purifier of claim 1 wherein said first operational state is a computer awake mode and said second operational state is a computer sleep mode.

3. The air purifier of claim 1 wherein said first operational state is a computer sleep mode and said second operational state is a computer awake mode.

4. An air purifier comprising; a housing; an electric motor; a fan coupled to said electric motor; an air filter mounted to extract impurities from an airstream passing through said housing; and a controller having means for automatically operating said electric motor in response to input signals received from a computer, said controller energizing said motor in response to a first computer mode input signal from the computer and de-energizing said motor in response to a second computer mode input signal from the computer.

5. The air purifier of claim 4 wherein said first computer mode input signal is a computer awake mode input signal and said second computer mode input signal is a computer sleep mode input signal.

6. The air purifier of claim 4 wherein said first computer mode input signal is a computer sleep mode input signal and said second computer mode input signal is a computer awake mode input signal.

7. A combination air purifier and computer comprising,
a computer capable of sending a first operational state signal associated with a first operational status of said computer and a second operational state signal associated with a second operational status of said computer, and
an air purifier having a housing having an air inlet and an air outlet, a filter mounted within said housing between said air inlet and said air outlet, a motorized fan configured to draw air into said housing through said air inlet, through said filter and out of said housing through said air outlet, and controller in communication with said computer, said controller operating the motorized fan at a first operational status upon receiving said first operational state signal from said computer and operating the motorized fan at a second operational status upon receiving said second operational state signal from said computer.

8. The air purifier of claim 7 wherein said first operational state signal is associated with an operational status of a computer awake mode and said second operational state signal is associated with an operational status of a computer sleep mode.

9. The air purifier of claim 7 wherein said first operational state signal is associated with an operational status of a computer sleep mode and said second operational state signal is associated with an operational status of a computer awake mode.

10. A combination air purifier and computer comprising,
a computer capable of generating and sending a sleep mode signal and an awake mode signal, and
an air purifier having a housing, a filter mounted within said housing, a motorized fan, and controller in communication with said computer, said controller operating the motorized fan at a first operational status upon receiving said sleep mode signal from said computer and operating the motorized fan at a second operational status upon receiving said awake mode signal from said computer.

11. The air purifier of claim 10 wherein said first operational status is an air purifier on mode and wherein said second operational status is an air purifier off mode.

12. The air purifier of claim 10 wherein said first operational status is an air purifier off mode and wherein said second operational status is an air purifier on mode.
